(19) United States
(12) Patent Application Publication
(10) Pub. No.: US 2007/0276927 A1
(43) Pub. Date: Nov. 29, 2007

(54) STREAMING PLAYER WITH TIME INDEX MEMORY AND CATALOG

(75) Inventor: Edward P. Flinchem, Seattle, WA (US)

Correspondence Address: BLACK LOWE & GRAHAM, PLLC, 701 FIFTH AVENUE, SUITE 4800, SEATTLE, WA, 98104, US

(73) Assignee: MELODEO INC., Seattle, WA (US)

(21) Appl. No.: 11/614,034

(22) Filed: Dec. 20, 2006

Related U.S. Application Data
(60) Provisional application No. 60/752,422, filed on Dec. 21, 2005.
(60) Provisional application No. 60/803,960, filed on Jun. 5, 2006.

(51) Int. Cl. G06F 15/16

(52) U.S. Cl. 709/219

(57) ABSTRACT

The present invention provides an intelligent client with a catalog of available streams and keeps a persistent record of each stream to which the user listens and the point at which they stop in each stream. An example method receives a selection for a streamed media file at a mobile communications device. The received selection is sent to a server via a mobile communications network and/or a public data network. A portion of the streamed media file that was not previously presented by the device is received from the server, if the streamed media file was interrupted during a previous presentation. The received portion of the streamed media file is presented on the device.

### PRIORITY CLAIM

This invention claims the benefit of U.S. Provisional Application Ser. Nos. 60/752,422 filed Dec. 21, 2005 and 60/803,960 filed Jun. 5, 2006, the contents of which are hereby incorporated by reference.

### BACKGROUND OF THE INVENTION

Memory limitations prevent common cell phones from storing lengthy content locally. Streaming is an option, but the user experience suffers when network connectivity is lost or user stops a stream to perform another task. In each case, user must start over from the beginning.

Therefore, there exists a need for improved usability of streamed digital content.

### SUMMARY OF THE INVENTION

The present invention provides an intelligent client with a catalog of available streams and keeps a persistent record of each stream to which the user listens and the point at which they stop in each stream. Connections may drop, batteries may die, etc., still, the user may return to any stream and pick up where they left off or “rewind” as desired.

An example method receives a selection for a streamed media file at a mobile communications device. The received selection is sent to a server via at least one of a mobile communications network and a public data network. A portion of the streamed media file that was not presented by the mobile communications device in a previous access by the mobile communications device is received from the server, if the streamed media file was interrupted during a previous presentation. The received portion of the streamed media file is presented on the mobile communications device.

In one aspect of the invention, an association between the streamed media file and a present segment of the streamed media file is stored and a segment counter based on the present segment is set. The presented portion of the streamed media file includes a segment that is based on the set segment counter and the stored association.

In another aspect of the invention, next segment is received during or after presentation of the present segment and presented after presentation of the present segment. The segment counter is updated based on the presented next segment and an association of the streamed media file and the next segment are stored.

In still another aspect of the invention, all stored associations between segments and the streamed media file are deleted if all the segments for the streamed media file have been presented

### BRIEF DESCRIPTION OF THE DRAWINGS

Preferred and alternative embodiments of the present invention are described in detail below with reference to the following drawings:

FIG. 1 is a schematic diagram of an example system formed in accordance with the present invention;

FIG. 2 is a flow diagram of an example process performed by the system shown in FIG. 1;

FIG. 3 is a schematic diagram of an example system formed in accordance with the present invention;

FIG. 4 is a flow diagram of an example process performed by the system shown in FIG. 3.

### DETAILED DESCRIPTION OF THE PREFERRED EMBODIMENT

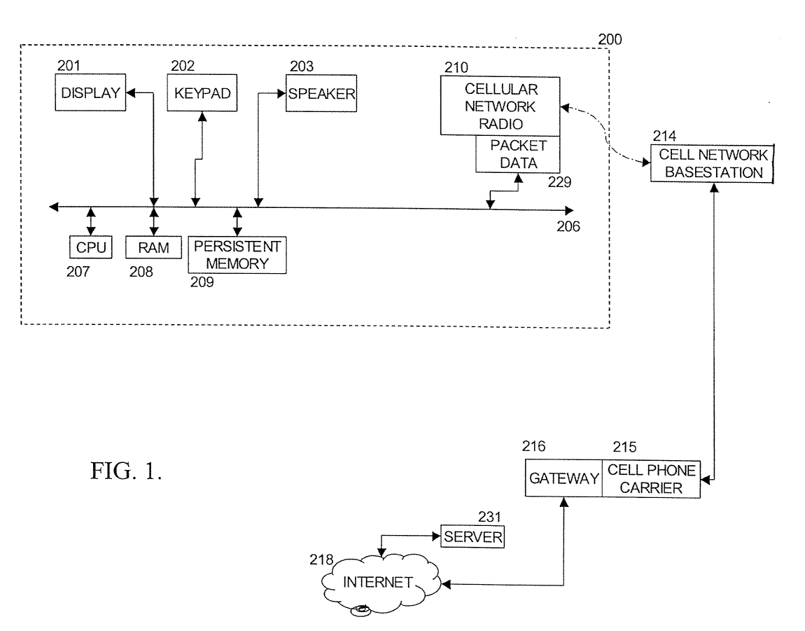

FIG. 1 shows a user device 200, such as a mobile phone, having a processor 207, random access memory 208, persistent memory 209 (which could be rewriteable FLASH memory), a display 201, a keypad 202, one or more speakers 203, and a cellular network radio data communication component 210. A data bus 206 connects the various elements within the device 200.

The radio component 210 allows data communications with a public or private data network 218, such as the Internet, via cellular wireless voice and data network basestations 214, associated mobile phone carrier 215 and a gateway 216. The radio component 210 sends and receives a variety of packet data 229 according to a predefined protocol (UDP, TCP, SMTP, HTTP, etc) through the data network 218.

Connected to the data network 218 is a server 231 or group of servers that enable the download of open or protected (encrypted) digital media files to the device 200 and digital content keys to unlock the protected content for use on the device 200 that are properly authenticated. The processor 207 executes previously stored client software that performs the process described below.

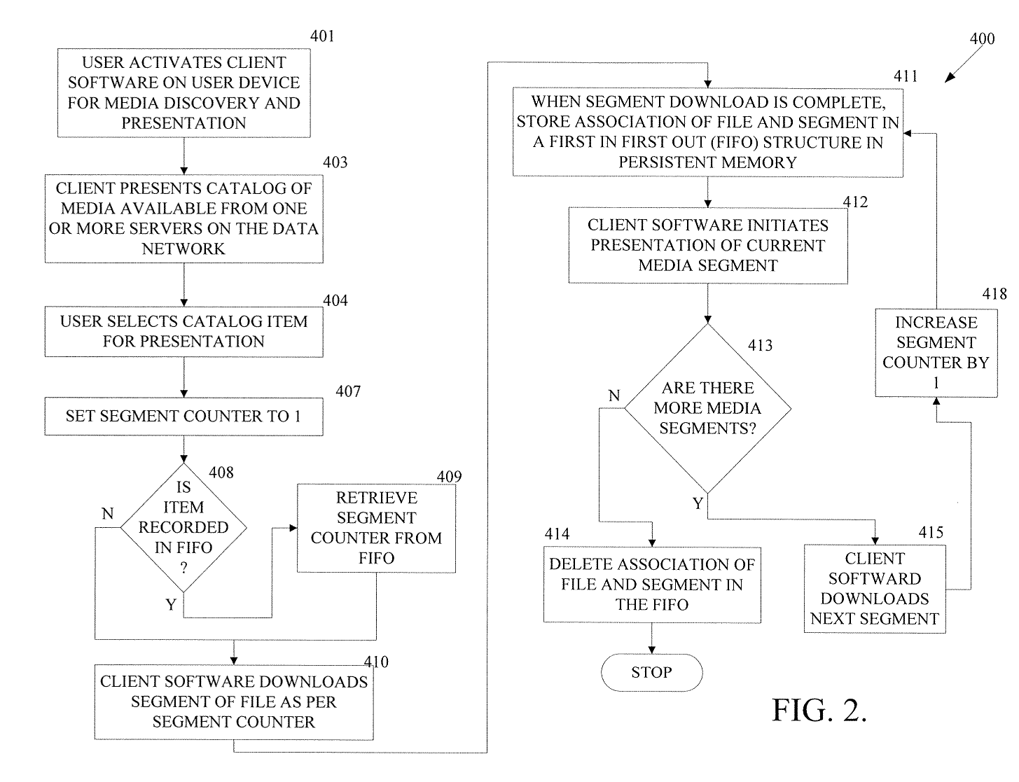

FIG. 2 illustrates an example process 400 for illustrating the present invention. First, at block 401, a user activates client software on the user device for discovery and presentation of a media file. At block 403, the client software presents a catalog of media files retrieved from one or more servers by transmission over the data network and cell phone system. At block 404, the user selects a media file from the catalog for presentation. At block 407, a segment counter is set to 1. At decision block 408, the processor determines if the media file has an association previously recorded in a first-in-first-out (FIFO) structure. At block 409, if the association of the media item was recorded in the FIFO structure, the segment counter is retrieved. At block 410, after block 409 or if the item was not recorded in the FIFO storage, the client software downloads the segment of the media file as per the retrieved segment counter or just the first segment of the media file. At block 411, when download of the segment is complete, an association of the media file and segment are stored in the FIFO storage.

At block 412, the client software initiates presentation of the current segment. At block 413, the process determines if there are more segments for the media file. If there are more segments, at block 415, the client software downloads the next segment and the process 400 returns to block 411. After block 415, at block 418 the segment counter is increased by one. If there are no more segments, at block 414, the association is deleted from the FIFO structure. At block 416, the process stops after block 414. The segment counter is just a working copy or local copy of one field of what is stored in the fifo for each file.

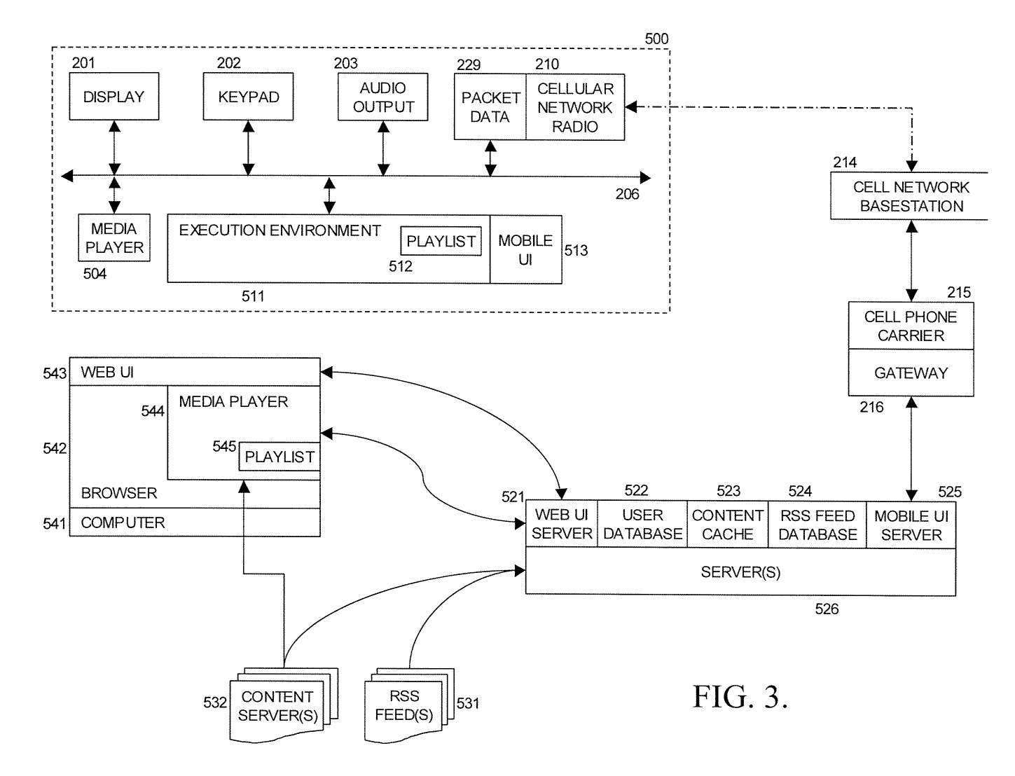

FIG. 3 shows a mobile phone 500 formed in accordance with an alternate embodiment. Text and graphical data are presented on a screen 501. Sound is put through an audio outputs(s) 503. A data bus 506 connecting the various elements within the phone. A media player 504 decodes compressed digital data into audiovisual outputs. A packet data interface 509 to communicate in any of several protocols (UDP, TCP, SMTP, HTTP, etc.) interfaces to a radio 510 to communicate with cellular wireless voice and data network basestations 214 through their associated mobile phone carrier 215 and onward through a gateway 216 to a public or private data network 218, such as the Internet.

A mobile user interface 513 interacts with a playlist 512 and runs on an execution environment 511. The execution environment 511 communicates using packet data over a cellular network to a mobile user interface server 525 that is part of a complex of servers 526. The complex of servers 526 includes functions of a database of RSS feeds 524, a mobile user interface server 525, a cache of content 523 transcoded into format(s) appropriate for delivery to and playback on the mobile phone 500, a database 522 associating each with state information for users' playlists. The server complex 526 polls data from RSS feeds 531 and pulls content from content servers 532.

The RSS feed are one means of publishing to the Internet the availability of content, especially when created or refreshed periodically, e.g., updated with new episodes or versions.

A user computer system 541 includes a web browser 542 interfaced to a media player 544 that interacts with a playlist 545 and communicates with a web server 521 to exchange state information of the playlist. The media player 544 also pulls content from other servers 532. A web user interface 534 runs on a browser 542 and interacts with the server 521.

A server with a catalog of available content maintains a database with records for each user of the content to which the user subscribes and which episodes of content have been consumed and what portion of each episode is consumed. Users may add and delete content from their subscriptions and consume content through either a web interface on a PC or an interface on their mobile device. The playlists 512, 545 present at least a portion of the content of a user's catalog(s). the list is stored on the server. In one embodiment the playlist 512 is stored persistently in memory of the phone 500 and is updated time to time by a server when the local copy is out of date. In another embodiment, client software running on the phone 500 retrieves the playlist from the server whenever it is activated.

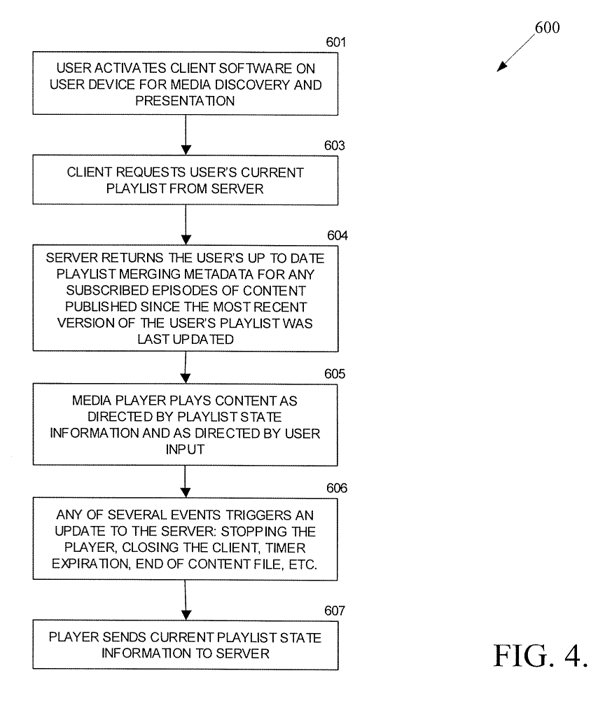

FIG. 4 illustrates an example process 600 performed by the system shown in FIG. 3. At block 601, a user activates client software on user device (the phone 500 or the system 541) for media discovery and presentation. Next, at block 603, the client software requests user's current playlist from the server 526. At block 604, the server returns the user's up-to-date playlist that includes metadata for any subscribed episodes of content published since the most recent version of the user's playlist was last updated. At block 605, the media player plays content as directed by playlist state information and as directed by user input. The playlist state information includes information regarding if a media file was paused during playing and which segment and where in the segment of the paused media file did the pause occur. At block 606, any of several events triggers an update to the server. The triggering events include stopping the player, closing the client, timer expiration, end of content file, or some other disruptive action. At block 607, the media player sends current playlist state information to the server.

In one example, Bob is a service technician employed by an airline. He is in the office in the late afternoon checking email. He is advised that an aircraft manufacturer is publishing a new series of service bulletins on an aircraft type flown by his employer. On his PC, using a browser, he opens the web interface whose function is described above and subscribes to the new series of service bulletins. His catalog is updated and recorded. He begins listening to the first service bulletin in the series. He pauses somewhere in the middle of the presentation of the first service bulletin to go home at the end of the day. The stopping place is recorded and saved at the server as playlist state information. While on his commute home, Bob activates the software client on his mobile phone. The software receives his updated catalog and playlist state information from the server, which now includes the service bulletin series to which he subscribed in the office earlier that day. He selects playback of the first bulletin in the series and playback resumes at the place he left off before he left his office.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is: claimed are defined as follows:

1. A method comprising:
receiving a selection for a streamed media file at at least one of a mobile communications device or a computer-based device;
sending the received selection to a server via at least one of a mobile communications network and a public data network;
receiving from the server a portion of the streamed media file that was not presented by the mobile communications device or the computer-based device in a previous access by the mobile communications device, if the streamed media file was interrupted during a previous presentation; and
presenting the received portion of the streamed media file.

2. The method of claim 1, wherein receiving comprises:
storing an association between the streamed media file and a present segment of the streamed media file; and
setting a segment counter based on the present segment.

3. The method of claim 2, wherein the presented portion of the streamed media file includes a segment that is based on the set segment counter and the stored association.

4. The method of claim 3, further comprising:
during or after presentation of the present segment, receiving a next segment;
presenting the received segment; and
updating the segment counter based on the presented next segment and storing an association of the streamed media file and the next segment.

5. The method of claim 1, further comprising:
deleting all stored associations between segments and the streamed media file, if all the segments for the streamed media file have been presented.

6. The method of claim 1, further comprising:
generating and storing information regarding the state of presentation of the streamed media file for a present user.

7. The method of claim 6, wherein presenting is further based on the stored state information.

8. The method of claim 7, further comprising storing the state information at a server that is in data communication with at least one of the mobile communications devices or another user device over a public data network and a cellular network.

9. The method of claim 8, wherein the state information includes a location in the streamed media file where at least one of a pause or interruption of the presentation of the streamed media file occurred.

10. The method of claim 9, wherein the state information for a plurality of streamed media files are presented to the user.

11. The method of claim 6, wherein generating the state information includes synchronizing the state information stored locally with state information received from the server.

12. A system for presentation of streamed media files, the system comprising:
a server for storing media files for streaming; and
at least one of a mobile communications device or other user computer-based device in data communication with the server over a public data network and a cellular network, the mobile communications device or other user computer-based device comprising:
a user interface for receiving a selection for a streamed media file;
a processor in data communication with the server and the user interface, the processor comprising:
a first component for sending the received selection to the server;
a second component for receiving from the server a portion of the streamed media file that was not presented by the mobile communications device or other user computer-based device in a previous access by the mobile communications device or other user computer-based device, if the streamed media file was interrupted during a previous presentation of the streamed media file and presenting the received portion of the streamed media file via the user interface.

13. The system of claim 12, wherein the second component stores an association between the streamed media file and a present segment of the streamed media file and sets a segment counter based on the present segment.

14. The system of claim 13, wherein the presented portion of the streamed media file includes a segment that is based on the set segment counter and the stored association.

15. The system of claim 14, wherein the second component receives a next segment during or after presentation of the present segment, presents the received next segment, updates the segment counter based on the presented next segment, and stores an association of the streamed media file and the next segment.

16. The system of claim 12, wherein the processor deletes all stored associations between segments and the streamed media file, if all the segments for the streamed media file have been presented.

17. The system of claim 12, wherein the server generates and stores information regarding the state of presentation of the streamed media file for a present user.

18. The system of claim 17, wherein the server transmits a portion of the streamed media file based on the stored state information.

19. The system of claim 18, wherein the state information includes a location in the streamed media file where at least one of a pause or interruption of the streamed media file occurred.

20. The system of claim 19, wherein the processor presents the state information for a plurality of streamed media files.

21. The system of claim 17, wherein generating the state information includes synchronizing the state information stored locally with state information received from the server.
